(19) United States
(12) Patent Application Publication
(10) Pub. No.: US 2005/0189519 A1
(43) Pub. Date: Sep. 1, 2005

(54) Composition comprising an initiator and a method of treating wood with the composition

(76) Inventors: Sven Gothe, Bromma (SE); Lennart Castwall, Akersberga (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 11/065,162

(22) Filed: Feb. 25, 2005

(30) Foreign Application Priority Data
Feb. 27, 2004 (SE) 0400472-7

(51) Int. Cl. C09K 15/04

(52) U.S. Cl. 252/399

(57) ABSTRACT

A composition comprising a vegetable oil, a hydrogen donor and an initiator, wherein the initiator has the formula (I): 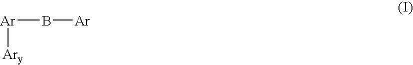
wherein Ar=aromatic group, Ar_{y}=0 or Ar, and B=I or S can be used to treat wood. The composition can include a solvent. Methods of treating wood comprise surface coating the wood with the composition or impregnating the wood with the composition, and heating the coated or impregnated wood at a temperature of at least 40° C. for at least 20 minutes.

### FIELD OF THE INVENTION

The present invention relates to a composition comprising a vegetable oil, a hydrogen donor, an initiator, and optionally a solvent. The invention further relates to a method of producing the inventive composition and a method of treating wood with the inventive composition.

### BACKGROUND OF THE INVENTION

Impregnation of wood in different applications can improve water resistance. Commonly used impregnation mediums are air-drying oils that are dried at room temperature and cured by an oxidation mechanism. To complete the curing of the oil in the impregnated wood, a 3 to 6 week time period is required. Many different oils are used, one of which is tung oil. Tung oil is usually diluted in n-paraffin to lower the viscosity and to achieve better impregnation results.

In the case of oxidation curing of the oil, the surface layer is first cured and then the layer next to the surface, until the interior is cured. Since diffusion of oxygen becomes slower when the oil is cured layer by layer from the exterior to the interior, it needs a long time to cure. The middle of the wood sometimes remains uncured. Some efforts to improve the curing of oil have been to use driers in the oil. Known driers include, for example, cobalt salts. However, when impregnating wood, a through-penetrating curing of the oil has not been achieved or has not been achieved in a reasonable time. Therefore, there is a need in the art for an improved method of impregnation of wood.

### SUMMARY OF THE INVENTION

The present invention solves the above-noted problem by a composition comprising a vegetable oil, a hydrogen donor, an initiator, and optionally a solvent. The initiator forms a cation and/or a free radical when the initiator is decomposed at a temperature above room temperature. The curing of the oil does not use the oxidation mechanism, thus, the curing mechanism does not need penetration of oxygen into the impregnated wood. This makes the wood impregnated throughout with impregnation medium that is fully cured.

The present invention also discloses a method of producing the composition and a method of treating wood with the composition.

### DETAILED DESCRIPTION

The present invention discloses a composition comprising a vegetable oil and optionally a solvent, wherein the composition also comprises a hydrogen donor and an initiator, wherein the initiator has the formula (I): 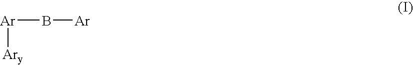
wherein Ar is an aromatic group, Ar_{y} is 0 (zero) or Ar, and B is I or S.

The initiator forms a cation and/or a free radical at temperatures above room temperature, which will be described further below. This composition is used for treating wood for impregnation. Thus, the present invention also refers to a method of treating wood with the composition.

The present invention uses a combination of a free radical and cationic mechanism when curing the oil. By the use of the free radical and cationic mechanism the oil can be completely dried after 0.5-4 hours. This is particularly true in applications where the vegetable oil is tung oil. The generation of free radicals and cations can be achieved by a thermal unstable initiator. The initiator will degrade and curing will take place at temperatures above 40° C. By using the free radical and cationic mechanism the oil be can cured simultaneously both in the interior and the exterior of the impregnated wood.

By curing the oil at an elevated temperature and using the free radical and cationic mechanism, the oil can be cured simultaneously both in the interior and the exterior, which gives the solvent (for tung oil, n-paraffin) an opportunity to evaporate. In the case of oils cured by the currently-used oxidation mechanism, the solvent to a large extent is caught in the wood due to the fact that the surface is the first portion cured and therefore the wood becomes sealed shortly after the curing starts. Further, the impregnation media (oil) is mainly cured on the surface and not in the interior of the wood.

The composition according to the present invention comprises an oil chosen from tung oil, soya bean oil, linseed oil, castor oil, safflower oil, perilla oil and tall oil. The solvent is chosen from aliphatic or aromatic solvents and is preferably chosen from n-paraffin and white spirit.

The initiator can be chosen from arylsulfonium salts or aryliodonium salts. Preferably, the initiator is a triarylsulfonium salt or a diaryliodonium salt. The triarylsulfonium salt or diaryliodonium salt is used in the composition in combination with a hydrogen donor. The initiator is thermally unstable at temperatures above 40° C. because of its chemical structure. The hydrogen donor is an additive chosen from tertiary bonded hydrogens on hydrocarbons, alcohols and amines. The vegetable oil or the solvent could also work as a hydrogen donor.

Examples of initiators which can be used are arylsulfonium salt, Degussa KI-85 (Degussa), Cyracure UVI-6922 or Cyracure UVI-6976 (both from Union Carbide), aryliodonium salts (GE and Rhone Poulenc). All types of wood can utilize the free radical and cationic mechanism to cure the oil. The curing technology can be used for both natural and compressed wood.

When the wood treated with the composition is heated, the initiator decomposes and forms a cation and/or a free radical, which participates in the curing mechanism. This curing mechanism is affected through the whole of the wood, not only on the surface. Thereby, a complete curing of the composition is effected. This is an advantage compared to the previously-known oxidative curing of oils. However, the method may also be used for surface treatment, since this is an effective way of surface coating wood.

The presumed reaction mechanism is described below. The initiator can form both free radicals and cations. The polymerization of the oil is probably a hybrid reaction by both free radical reactions and cationic reactions. Without wishing to be bound by any particular theory, the applicant assumes that the reactions are as follows.
Ar₃S+X−→Ar₂S+•—X—+Ar• (the reaction starts at elevated temperature)
Ar₂+•X—+ZH→Ar₂S•+Z•+HX
Ar₂I+X—+ZH→ArI+Z•+HX+Ar• (the reaction starts at elevated temperature)
ZH is a hydrogen donator agent
X is BF₄—, PF₆—, SbF₆— and others (counter ions in the salt)

The present invention preferably refers to a composition wherein the composition comprises
a) 10-100 percent by weight of oil,
b) 0 to 90 percent by weight of solvent,
c) 0.01-5 percent by weight of initiator and
d) 0-1.5 percent by weight of hydrogen donor as an additive, chosen from tertiary bonded hydrogens on hydrocarbons, alcohols and amines.

Another subject of the present invention is a method of producing a composition comprising a vegetable oil, optionally a solvent, an initiator and a hydrogen donor, wherein the method comprises the steps of
a) the initiator is optionally solved in a part of the solvent,
b) the initiator, optionally solved in the solvent, optionally the remainder of the solvent, the oil and the hydrogen donor are brought together and mixed.

As mentioned above, the present invention refers to a method of treating wood with a composition according to that described above, comprising the steps of
a) surface coating the wood with the composition or
b) impregnating the wood with the composition, and
c) heating the coated or impregnated wood at a temperature of at least 40° C. for at least 20 minutes.

The method according to the present invention preferably involves heating in step c) at a temperature of at least 60° C. for at least 10 minutes, even more preferably at a temperature of at least 70° C. for at least 10 minutes and most preferably at a temperature of at least 100° C. for at least 5 minutes. The time is also preferably at least 10 minutes when a temperature of 50° C. is used. The temperature and time of the curing depends on which oil is used, on which initiator is used and the content of the solvent. Which temperature should be used can be evaluated by the person skilled in the art. This depends on the choice of oil, solvent and initiator to be used in the composition and it also depends on the content of the different parts.

According to the inventive impregnation process the voids in the wood piece are replaced by the oil. When the oil is cured, the cells in the piece of wood are “locked” giving a better water and shape stability. The composition according to the present invention can also comprise further additives such as pigment, preservative agent, antioxidants etc.

The present invention cures the oil composition with a new mechanism and thereby the oil dries within 0.5-4 hours compared to 3-6 months with the oxidation mechanism. This allows for the possibility to on-line coat or adhere the impregnated wood with lacquer in a production process. The composition according to the present invention could be used when impregnating wood which is intended for use as parquet. The impregnated wood could also be lacquered after the impregnation treatment.

Further, the composition could be used to impregnate wood which can be used outdoors, such as outdoor furniture, wood for porches etc. All wood intended for indoor use may be impregnated with the composition according to the present invention.

The present invention will now be described with the aid of the following examples.

### EXAMPLE 1

### Evaluation of Adhesion of Water-Based UV Lacquer on Wood Impregnated with Tung Oil Without Initiator

Alder and birch were impregnated with tung oil (without initiator, vacuum time 20 minutes (0.2 to 0.3 atmospheres), normal pressure 5 minutes). The samples were dried at 20° C. for differing numbers of days. A water-based UV lacquer was then applied (40 μm wet, UV curing in a Minicure apparatus, the lacquer dries instantaneously). Adhesion was measured with the crosshatch method with and without tape after different oil drying times (number of days). The crosshatch method is described in Organic coatings, Vol. 2, page 168; John Wiley & Sons Inc., 1994, Authors: Wicks, Jones, Pappas.

Compositions used in the Examples:

| | |
|---|---|
| Tung oil | 33% |
| Cyracure UVI-6976 | 0.02%* |
| White spirit | 0.15% |
| n-paraffin | 66.83% |

*The content of Cyracure differs according to the examples below

TABLE 1
Crosshatch without tape

| | Oil drying | Oil drying | Oil drying | Oil drying |
|---|---|---|---|---|
| Type of wood | time 1 day | time 3 days | time 10 days | time 21 days |
| Alder | 5% | 15% | 40% | 65% |
| Birch | 5% | 10% | 35% | 60% |

Values given as a percentage indicate the number of intact crosshatch squares as a percent of the total squares.

TABLE 2
Crosshatch with tape

| | Oil drying | Oil drying | Oil drying | Oil drying |
|---|---|---|---|---|
| Type of wood | time 1 day | time 3 days | time 10 days | time 21 days |
| Alder | 0% | 10% | 30% | 55% |
| Birch | 0% | 5% | 30% | 50% |

Values given as a percentage indicate the number of intact crosshatch squares as a percent of the total squares.

### EXAMPLE 2

### Evaluation of Adhesion of Water-Based UV Lacquer on Wood Impregnated with Tung Oil Containing 0.5 Weight-% Initiator

Alder and birch were impregnated with tung oil (0.5 weight-% initiator, vacuum time 20 minutes (0.2 to 0.3 atmospheres), normal pressure 5 minutes). The samples were dried 25 minutes at 80° C. A water-based UV lacquer was applied (40 μm wet, UV curing in a Minicure apparatus). Adhesion was evaluated with the crosshatch method with and without tape after different amounts of time following application of lacquer (number of days).

TABLE 3
Crosshatch without tape

| | Time after | Time after | Time after | Time after |
|---|---|---|---|---|
| | lacquer | lacquer | lacquer | lacquer |
| | application | application | application | application |
| Type of wood | 1 day | 3 days | 10 days | 21 days |
| Alder | 90% | 95% | 90% | 95% |
| Birch | 85% | 90% | 90% | 90% |

Values given as a percentage indicate the number of intact crosshatch squares as a percent of the total squares.

TABLE 4
Crosshatch with tape

| | Time after | Time after | Time after | Time after |
|---|---|---|---|---|
| | lacquer | lacquer | lacquer | lacquer |
| | application | application | application | application |
| Type of wood | 1 day | 3 days | 10 days | 21 days |
| Alder | 90% | 90% | 90% | 90% |
| Birch | 90% | 90% | 90% | 85% |

Values given as a percentage indicate the number of intact crosshatch squares as a percent of the total squares.

### EXAMPLE 3

### Evaluation of Adhesion of Acid-Cured and Water-Based UV Lacquers on Wood Impregnated with Tung Oil Containing 0.5 Weight-% Initiator

Alder and birch were impregnated with tung oil (0.5 weight-% initiator, vacuum time 20 minutes (0.2 to 0.3 atmospheres), normal pressure 5 minutes). The samples were dried 25 minutes at 80° C. A water-based UV lacquer was applied (40 μm wet, UV curing in a Minicure apparatus) and an acid-curing lacquer was applied (40 μm wet, 10 minutes at 80° C.). Adhesion was evaluated with the crosshatch method with and without tape after 1 day of drying at normal temperature following the drying at 80° C.

TABLE 5
Crosshatch without tape.

| Type of wood | Acid-curing Lacquer | Water-based UV Lacquer |
|---|---|---|
| Alder | 95% | 95% |
| Birch | 90% | 95% |

Values given as a percentage indicate the number of intact crosshatch squares as a percent of the total squares.

TABLE 6
Crosshatch with tape.

| Type of wood | Acid-curing Lacquer | Water-based UV Lacquer |
|---|---|---|
| Alder | 85% | 85% |
| Birch | 80% | 85% |

Values given as a percentage indicate the number of intact crosshatch squares as a percent of the total squares.

Adhesion of the water-based UV lacquer on alder and birch impregnated with tung oil without initiator is improved with prolonged drying time for the oil in air. But the adhesion is not sufficient after 21 days, which can be seen in tables 1 and 2. Adhesion for the water-based UV and the acid-cured lacquers on alder and birch impregnated with tung oil with 0.5 weight-% initiator and dried 25 minutes at 80° C. passed the requirements (tables 3-6). The results show that tung oil with 0.5 weight-% initiator and dried 25 minutes at 80° C. can be lacquered directly after drying.

### EXAMPLE 4

### Evaluation of Lacquering for Parquet Flooring Construction

Wood samples of oak, pine, birch and alder were impregnated with tung oil containing 0.5 weight-% initiator. The impregnation process for the wood samples was done with a vacuum time of 20 minutes (0.2 to 0.3 atmospheres), normal pressure for 5 minutes and a drying time of 25 minutes at 80° C. The wood samples were glued onto a wooden substrate to resemble a parquet flooring construction.

The parquet flooring construction samples were lacquered (two days after the parquet flooring construction samples were done) with: water base coat+UV-base coat+UV-base coat+UV-base coat+UV-top lacquer.

The lacquered samples were evaluated in a climate chamber test. The 4 different types of wood were tested in the climate chamber during 56 cycles of 4 hours each according to the following schedule:
20° C., RH (Relative humidity) 0%
25° C., RH 65%
60° C., RH 90%
25° C., RH 65%

Results of stain resistance, crosshatch, adhesion and abrasion resistance of the samples tested in the climate chamber according to the description, above, are shown in Table 7, below. Controls (normal parquet flooring system), treated in the same way, are also shown in Table 7.

TABLE 7

| | | | | Abrasion |
|---|---|---|---|---|
| | Stain resistance | | | resistance |
| | (shoe polish, | | Adhesion | (According to |
| System | lip stick, coffee) | Crosshatch | (coin test) | DIN standard) |
| Samples | OK | 100% | OK | OK |
| according | | | | |
| to the | | | | |
| invention | | | | |
| Control | OK | 100% | OK | OK |

The climate chamber tests show that the technology according to the present invention fulfils the demands for parquet flooring and can be used on-line in a parquet flooring manufacturing line. This can be compared with the fact that wood samples treated with tung oil and air dried (without initiators) need at least 2 months of storage before they can be lacquered on-line in a parquet flooring manufacturing line.

### EXAMPLE 5

### Test of Different Amounts of Initiator

Alder wood samples were impregnated with tung oil containing 0 weight-%, 0.25 weight-%, 0.5 weight-%, 0.75 weight-% and 1.00 weight-% initiator (the initiator was a 10% by weight solution of Cyracure UVI 6976 (Mixed Triaryl sulfonium Hexafluoroantimonate Salts, Union Carbide) and white spirit). The impregnation process for the wood samples was done with a vacuum time of 20 minutes (0.2 to 0.3 atmospheres), normal pressure for 5 minutes and a drying time of 25 minutes at 80° C. The samples of dried tung oil-impregnated alder were evaluated by a 24-hour water test.

In table 8 below the result of the water test is shown. In the water test a droplet of water is added onto the wood sample. The wood sample is evaluated for swelling.

TABLE 8

| | Concentration of initiator | | | | |
|---|---|---|---|---|---|
| | 0.0% | 0.25% | 0.50% | 0.75% | 1.00% |
| % of wood samples | 95% | 75% | 65% | 50% | 60% |
| effected by swelling | | | | | |

Water resistance is greatly improved by adding the initiator to the tung oil and drying it at 80° C. for 25 minutes.

### EXAMPLE 6

### Effect of Curing Temperature

Six different curing temperatures were evaluated by the water resistance test to show the effect of curing temperature. Alder wood samples were impregnated with tung oil containing 0.5 weight-% initiator (the initiator was a 10% by weight solution of Cyracure UVI 6976 (Union Carbide) and white spirit). The impregnation process for the wood samples was done with a vacuum time of 20 minutes (0.2 to 0.3 atmospheres), normal pressure for 5 minutes and a drying time of 20 minutes. The drying temperature was from 50° C. to 130° C. The alder wood samples impregnated with tung oil and then dried were evaluated by a 24-hour water test.

In table 9 below the result of the water test is shown. In the water test a droplet of water is added onto the wood sample. The wood sample is evaluated for swelling.

TABLE 9

| | Curing temperature | | | | | |
|---|---|---|---|---|---|---|
| | 50° C. | 70° C. | 80° C. | 90° C. | 110° C. | 130° C. |
| % of wood | 100% | 65% | 60% | 55% | 40% | 20% |
| samples | | | | | | |
| effected by | | | | | | |
| swelling | | | | | | |

Water resistance is improved with increased temperature due to a better cross-linking of the tung oil. Temperatures above 110° C. show a tendency of surface wrinkles on the wood sample.

Temperatures above 40° C. are needed to start the cross-linking process. This is because the initiator does not become active until temperatures above about 40° C. or 50° C. are reached.

### EXAMPLE 7

### Effect of Curing Time

Alder wood samples were impregnated with tung oil containing 0.5% catalyst (the catalyst was a 10% by weight solution of Cyracure UVI 6976 (Union Carbide) and white spirit). The impregnation process for the wood samples was done with a vacuum time of 20 minutes (0.2 to 0.3 atmospheres), normal pressure for 5 minutes and a drying time which varied between 5 and 30 minutes. The drying temperature was 80° C. The tung oil-impregnated alder wood samples, which were dried, were then evaluated by a 24-hour water test.

Table 10 below shows the result of the water test. In the water test a droplet of water is added onto the wood sample. The wood sample is evaluated for swelling.

TABLE 10

| | Curing time in minutes | | | | |
|---|---|---|---|---|---|
| | 5 | 10 | 15 | 20 | 30 |
| % of wood samples effected by | 80% | 60% | 45% | 50% | 75% |
| swelling | | | | | |

### EXAMPLE 8

### Test of Different Initiators

Three different initiators were evaluated. The initiators were 1) triarylsulphonium salt (PF6-), 2) triarylsulphonium salt (SbF6-) and 3) diaryliodonium salt (PF6-).

Oak wood samples were impregnated with tung oil containing 0.5 weight-% initiator (the initiator was a 10% by weight solution of the initiator in white spirit). The impregnation process for the wood samples was done with a vacuum time on 15 minutes (0.2 to 0.3 atmospheres), normal pressure for 3 minutes and a drying time of 15 minutes at 100° C. The oak wood samples, impregnated with tung oil and then dried, were evaluated by a 24-hour water test.

Table 11 below shows the result of the water test. In the water test a droplet of water is added onto the wood sample. The wood sample is evaluated for swelling.

TABLE 11

| | Type of initiator | | |
|---|---|---|---|
| | 1 | 2 | 3 |
| % of wood samples effected | 55% | 50% | 65% |
| by swelling | | | |

The triarylsulphonium salt (SbF6-) was performing best in the test.

### EXAMPLE 9

### Test of Through-Curing of the Oil

Wood pieces of 12 cm×50 cm with a thickness of 0.5 cm were impregnated with tung oil with the same process parameters as in Example 6 and a drying temperature of 100° C. After drying the wood pieces were cut in the middle into 2 pieces (each with a length of 25 cm). Investigation of the cross-section showed that the oil had penetrated through the whole cross section of the wood piece. By varying the vacuum time and normal pressure time different degrees of oil penetration into the cross-section of the wood piece can be achieved.

A test to check if the tung oil was cured in the interior of the wood piece was performed by clipping the cut wood piece with a pincers. No liquid tung oil could be pressed out from the wood piece. Tests with tung oil without catalyst showed after the same process when the wood piece was clipped with the pincers that tung oil droplets came out of the interior of the wood piece.

1. A composition, comprising:
a vegetable oil;
a hydrogen donor; and
an initiator,
wherein the initiator has the formula (I): 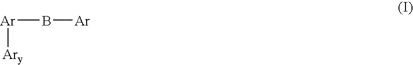
and wherein Ar is an aromatic group;
Ar_{y} is 0 (zero) or Ar; and
B is I or S.

2. A composition according to claim 1, further comprising a solvent.

3. A composition according to claim 1, wherein the vegetable oil is selected from the group consisting of tung oil, soya bean oil, linseed oil, castor oil, safflower oil, perilla oil and tall oil.

4. A composition according to claim 2, wherein the solvent is selected from the group consisting of aliphatic solvents and aromatic solvents.

5. A composition according to claim 4, wherein the solvent is selected from the group consisting of n-paraffin and white spirit.

6. A composition according to claim 1, wherein the initiator is selected from the group consisting of arylsufonium salts and aryliodonium salts.

7. A composition according to claim 6, wherein the initiator is selected from the group consisting of triarylsufonium salt and diaryliodonium salt.

8. A composition according to claim 1, wherein the hydrogen donor is selected from the group consisting of tertiary bonded hydrogens on hydrocarbons, alcohols and amines.

9. A composition according to claim 2, wherein the composition comprises:
10-100 percent by weight of oil;
0 to 90 percent by weight of solvent;
0.01-5 percent by weight of initiator; and
0-1.5 percent by weight of hydrogen donor, and
wherein the hydrogen donor is selected from the group consisting of tertiary bonded hydrogens on hydrocarbons, alcohols, and amines.

10. A method of producing a composition according to claim 2, comprising:
solving the initiator in a portion of the solvent; and
mixing the vegetable oil, the hydrogen donor, the solved initiator, and a remaining portion of the solvent to form a composition.

11. A method of treating wood with a composition according to claim 1, comprising:
surface coating the wood with the composition or impregnating the wood with the composition; and
heating the coated or impregnated wood at a temperature of at least 40° C. for at least 20 minutes.

12. A method of treating wood according to claim 11, wherein the wood is heated at a temperature of at least 60° C. for at least 10 minutes.

13. A method of treating wood according to claim 12, wherein the wood is heated at a temperature of at least 70° C. for at least 10 minutes.

14. A method of treating wood according to claim 13, wherein the wood is heated at a temperature of at least 100° C. for at least 5 minutes.
